(19) United States
(12) Patent Application Publication
(10) Pub. No.: US 2007/0160708 A1
(43) Pub. Date: Jul. 12, 2007

(54) Process for the production of confectionery products

(75) Inventors: Andrew Gordon Johnston, Berkshire (GB); Kevin J. Stanton, Califon, NJ (US); Tami Hodanko, Liben (CZ); Yang Yu, Beijing (CN)

Correspondence Address: FITZPATRICK CELLA HARPER & SCINTO, 30 ROCKEFELLER PLAZA, NEW YORK, NY, 10112, US

(73) Assignee: Mars Incorporated, McLean, VA (US)

(21) Appl. No.: 10/557,821

(22) PCT Filed: May 28, 2004
(86) PCT No.: PCT/GB04/02303

§ 371 Date: Feb. 12, 2007

(30) Foreign Application Priority Data
May 30, 2003 (GB) 0312477.3

(51) Int. Cl. A23G 4/18

(52) U.S. Cl. 426/5

(57) ABSTRACT

A process for the continuous production of confectionery products comprising crystallised xylitol comprising: feeding xylitol in liquid form which is capable of crystallisation on cooling into a mixer together with xylitol seed crystals; mixing the xylitol in liquid form and the xylitol seed crystals to produce a seeded mass; and discharging the seeded mass from the mixer, wherein the mixer is maintained at a temperature of between 80° C. and 120° C., whereby build up of crystallised xylitol within the mixer is substantially prevented. The xylitol in liquid form may be molten xylitol or a solution of xylitol and may comprise xylitol alone or in high proportion in combination with other polyols.

The invention relates to a process for the continuous production of confectionery products comprising crystallised xylitol.

A number of sugar alcohols or polyols, such as xylitol and erythritol, are known to deliver a cooling effect in the mouth when consumed due to their large negative heats of solution.

Crystalline hard candies comprising xylitol are known. In order to prepare such candies a molten mass comprising xylitol, either alone or in high proportion in combination with other polyols, is mechanically agitated or seeded with xylitol crystals to cause crystallisation. The resultant seeded mass is then poured into moulds to produce hard candy.

Once the seed crystals have been added, the viscosity of the seeded molten mass is very difficult to control. The seeded mass thickens and crystallises rapidly if the temperature falls below the melting point of xylitol, but thins due to melting of the seed crystals if the temperature drifts above the melting point. As a result, the viscosity of the seeded mass tends to vary upon storage which is particularly undesirable on deposited hard candy manufacturing lines where any inconsistency in the viscosity of the seeded mass leads to inconsistent piece weight.

The difficulty associated with the handling of seeded molten xylitol has until now prevented the satisfactory continuous production of crystallised xylitol based confectionery products.

EP-A-0 528 604 discloses a continuous process for forming melt cocrystallized sorbitol/xylitol in which a homogenous molten blend of sorbitol and xylitol is cooled under agitation until a viscous mass is formed. The viscous mass is then removed from the agitation means and cooled slowly until the sorbitol/xylitol blend becomes fully crystalline. In this process, crystallisation of the xylitol is achieved by cooling and agitation. For crystallisation to occur, the internal temperature of the agitation means must be lower than the melting point of the sorbitol/xylitol blends, resulting in a steady build-up of crystallised material on the surfaces of the agitation means. During continuous processing, the steady build-up of crystalline material on the inner surfaces of the agitation means will reduce the internal volume of the agitation means and hence residence time of the sorbitol/xylitol blend at a fixed throughput rate. Such changes during continuous processing may lead to undesirable variations in the cocrystallized sorbitol/xylitol products produced.

GB 1 583 573 discloses a batch process for making xylitol-containing hard caramels in which 10 to 30% by weight of powdered xylitol is added to a xylitol melt, while stirring, at a temperature not substantially exceeding the melting point of xylitol. The resulting mass is then poured into moulds and left to solidify. For the reasons discussed above, it is difficult to maintain large batches of seeded molten xylitol at a steady viscosity. Hence, during processing of a large batch by this prior art process the properties of the seeded molten mass will change. While it is possible to work this process on a small scale, the process is difficult to work on a large scale.

According to the present invention there is provided a process for the continuous production of confectionery products comprising crystallised xylitol comprising: feeding xylitol in liquid form which is capable of crystallisation on cooling into a mixer together with xylitol seed crystals; mixing the xylitol in liquid form and the xylitol seed crystals to produce a seeded mass; and discharging the seeded mass from the mixer, wherein the mixer is maintained at a temperature of between 80° C. and 120° C., whereby build up of crystallised xylitol within the mixer is substantially prevented.

Preferably, the mixer is maintained at a temperature of between about 93° C. and about 100° C., more preferably at a temperature of between about 95° C. and about 97° C.

The xylitol in liquid form may be molten xylitol or a solution of xylitol and may comprise xylitol alone or in high proportion in combination with other polyols. Where the xylitol in liquid form comprises xylitol alone, the mixer is preferably maintained at a temperature of between about 90° C. and about 120° C.

Throughout the specification, low moisture xylitol syrup is used to mean a xylitol syrup having a moisture content of 10% by weight or less. Preferably, the low moisture xylitol syrup has a moisture content of 5% by weight or less, more preferably the low moisture xylitol syrup has a moisture content of 1% by weight or less.

Preferably, the low moisture xylitol syrup is fed into the mixer at a temperature of between about 170° C. and about 210° C., more preferably at a temperature of between about 200° C. and about 205° C.

In the mixer, heat is removed from the low moisture xylitol syrup through melting of a substantial amount of the powdered xylitol added as seed. Preferably, the ratio by weight of low moisture xylitol syrup to xylitol seed crystals fed into the mixer is between about 30:70 and about 60:40, more preferably between about 40:60 and about 50:50.

Preferably, where the process comprises feeding molten xylitol into a mixer together with xylitol seed crystals, the ratio by weight of molten xylitol to xylitol seed crystals is between about 90:10 and about 50:50, more preferably the molten xylitol and xylitol seed crystals are fed into the mixer in a ratio of about 75% to about 25% by weight.

Preferably, the molten xylitol is fed into the mixer at a temperature of between about 92° C. and about 200° C., more preferably at a temperature of between about 94° C. and about 160° C., most preferably at a temperature of between about 94° C. and about 115° C.

Preferably, the mixer is equipped with a planetary agitator.

It will be appreciated that the precise ratio of low moisture xylitol syrup or molten xylitol to seed crystals employed will depend upon, amongst other things, the temperature of the low moisture xylitol syrup or molten xylitol fed into the mixer, the temperature at which the mixer is maintained and the residence time of the seeded mass in the mixer.

The viscosity of the seeded mass in the mixer can be readily controlled through variation of the feed rates of the molten xylitol or low moisture xylitol syrup and/or xylitol seed crystals.

Additives commonly used in the manufacture of confectionery products, such as colours, flavours and acids, may be added to seeded mass during mixing.

The invention will now be further described, by way of example.

### EXAMPLE 1

Powdered xylitol was dissolved in water to form an 80% xylitol solution (by weight solids) at 80° C. The solution was evaporated in a scraped surface heat exchanger to produce a xylitol syrup containing 2% moisture. The resulting cooked syrup was fed at a temperature of 195° C. and a feed rate of 0.38 kg/min. into a 30 litre oil jacketed in-line mixer equipped with a planetary agitator with vessel walls maintained at 95° C. while stirring. Xylitol powder (90 μm grade, Xylisorb® 90 from Roquette) at ambient temperature was also fed into the mixer at a feed rate of 0.56 kg/min. After 12 minutes, with approximately 10 kg of seeded mass held in the mixer, an adjustable outlet at the base of the mixer was opened and the seeded mass discharged from the mixer at a rate of 0.84 kg/min. into a hard candy depositing line hopper through an oil jacketed feed pipe. The exit tap was heated with trace electrical heating tape to a temperature of 95° C. to 100° C. and the feed pipe was maintained at a temperature of approximately 95° C.

### EXAMPLE 2

Powdered xylitol was melted in a screw feeder at 150° C. The resulting molten xylitol was fed at a temperature of 96° C. to 100° C. and a feed rate of 0.6 kg/min. into a 30 litre oil jacketed in-line mixer equipped with a planetary agitator with vessel walls maintained at 95° C. while stirring. Xylitol powder (90 μm grade), Xylisorb® 90 from Roquette) at ambient temperature was also fed into the mixer at a feed rate of 0.24 kg/min. After 12 minutes, with approximately 10 kg of seeded mass held in the mixer, an adjustable outlet at the base of the mixer was opened and the seeded mass discharged from the mixer at a rate of 0.84 kg/min. into a hard candy depositing line hopper through an oil jacketed feed pipe. The exit tap was heated with trace electrical heating tape to a temperature of 95° C. to 100° C. and the feed pipe was maintained at a temperature of approximately 95° C.

In examples 1 and 2 the sum of the feed rates of the xylitol in liquid form and the xylitol seed crystals into the mixer is equal to the rate at which the seeded mass is discharged from the mixer thereby ensuring that the mass is maintained at a steady level in the mixer during continuous processing.

In examples 1 and 2 the temperature of the mixer is maintained at or just above the melting point of xylitol; the melting point of xylitol is about 94° C. Crystallisation of the seeded mass on the internal surfaces of the mixer is thereby substantially prevented. The temperature at which the mixer is maintained and the residence time of the seeded mass in the mixer in the examples are such that no significant melting out of the added seed crystals occurs. It will be appreciated that if the xylitol in liquid form comprises, for example, other polyols, the temperature at which the mixer is maintained may be reduced provided that it is still such that crystallisation of the seeded mass on the internal surfaces of the mixer is substantially prevented.

It will be appreciated that while in the examples given above the mixing vessel is an in-line mixer equipped with a planetary agitator, other mixing vessels could be employed, such as screw action mixers, mixer extruders, jacketed dough beaters or jacketed fondant beaters.

It will also be appreciated that while in example 2 above the powdered xylitol is melted in a screw feeder, other means suitable for the continuous production of molten xylitol could be employed.

1. A process for the continuous production of confectionery products comprising crystallised xylitol comprising the steps of:
feeding xylitol in liquid form which is capable of crystallisation on cooling into a mixer together with xylitol seed crystals;
mixing the xylitol in liquid form and the xylitol seed crystals to produce a seeded mass; and
discharging the seeded mass from the mixer, wherein the mixer is maintained at a temperature of between 80° C. and 120° C., whereby build up of crystallised xylitol within the mixer is substantially prevented.

2. A process according to claim 1 wherein the mixer is maintained at a temperature of between 90° C. and 120° C.

3. A process according to claim 1 wherein the mixer is maintained at a temperature of between 93° C. and 100° C.

4. A process according to claim 1, wherein the mixer is maintained at a temperature of between 95° C. and 97° C.

5. A process according to claim 1 wherein the xylitol in a liquid form is molten xylitol or a low moisture xylitol syrup.

6. A process according to claim 5 wherein the ratio by weight of low moisture xylitol syrup to xylitol seed crystals fed into the mixer is between 30:70 and 60:40.

7. A process according to claim 5 wherein the ratio by weight of low moisture xylitol syrup to xylitol seed crystals fed into the mixer is between 40:60 and 50:50.

8. A process according to claim 5 wherein the low moisture xylitol syrup has a moisture content of 5% or less by weight.

9. A process according to claim 5 wherein the low moisture xylitol syrup has a moisture content of 1% or less by weight.

10. A process according to claim 5 wherein the low moisture xylitol syrup is fed into the mixer at a temperature of between 170° C. and 210° C.

11. A process according to claim 5 wherein the low moisture xylitol syrup is fed into the mixer at a temperature of between 200° C. and 205° C.

12. A process according to claim 5 wherein the ratio by weight of molten xylitol to xylitol seed crystals fed into the mixer is between 90:10 and 50:50.

13. A process according to claim 12 wherein the molten xylitol and xylitol seed crystals are fed into the mixer in a ratio of about 75% to about 25% by weight.

14. A process according to claim 5 wherein the molten xylitol is fed into the mixer at a temperature of between 92° C. and 200° C.

15. A process according to claim 14 wherein the molten xylitol is fed into the mixer at a temperature of between 94° C. and 160° C.

16. A process according to claim 14 wherein the molten xylitol is fed into the mixer at a temperature of between 94° C. and 115° C.

17. A process according to claim 1 wherein the mixer is equipped with a planetary agitator.

18. (canceled)
